(19) United States
(12) Patent Application Publication
(10) Pub. No.: US 2010/0159283 A1
(43) Pub. Date: Jun. 24, 2010

(54) MAGNETIC STORAGE MEDIUM, MANUFACTURING METHOD OF MAGNETIC STORAGE MEDIUM, AND INFORMATION STORAGE DEVICE

(75) Inventors: Takahiro IBUSUKI, Kokubunji-shi (JP); Masashige SATO, Kokubunji-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 12/582,306

(22) Filed: Oct. 20, 2009

(30) Foreign Application Priority Data
Oct. 21, 2008 (JP) 2008-271317

(51) Int. Cl. G11B 5/66; B05D 5/12

(52) U.S. Cl. 428/829; 428/827; 427/131

(57) ABSTRACT

A magnetic storage medium includes a substrate, a first magnetic layer film that is deposited on the substrate, and a second magnetic layer film that is a cap layer of the first magnetic layer film. The first magnetic layer film contains a high magnetic anisotropic material and a low-temperature diffusion material which is added to the high magnetic anisotropic material, the low-temperature diffusion material starting diffusion by thermal treatment at a lower temperature than that of the high magnetic anisotropic material. The second magnetic layer film includes a material for promoting diffusion of the low-temperature diffusion material.

### CROSS-REFERENCE TO RELATED APPLICATION(S)

This application is based upon and claims the benefit of priority from Japanese Patent Application No. 2008-271317, filed on Oct. 21, 2008, the entire contents of which are incorporated herein by reference.

### FIELD

The present invention relates to a magnetic storage medium, a manufacturing method of a magnetic storage medium, and an information storage device.

### BACKGROUND

Recently, recording density of a magnetic storage medium to record information in higher density has been increased. The increase in recording density causes decreasing of a volume of one bit to record information, and also causes loss of information due to the influence of heat fluctuation.

To suppress the heat fluctuation, it suffices to increase magnetic anisotropic energy to be sufficiently larger than thermal energy. To increase magnetic anisotropic energy to become sufficiently larger than thermal energy, it is preferable to use a material having high magnetic anisotropy for a storage medium.

“FePt” and “CoPt” having an L1o structure, for example, are available as a material having high magnetic anisotropy. Materials such as “FePt” and “CoPt” have high magnetic anisotropy by providing an ordered alloy of an L1o structure from a face-centered cubic lattice (fcc) structure. However, the temperature of thermal treatment required to obtain the ordered alloy becomes considerably high. For example, thermal treatment at around 600° C. is necessary for ordering a film including “FePt” or “CoPt” deposited thereon.

Various techniques have been disclosed to suppress the thermal treatment temperature required for ordering an alloy such as “FePtB” and “CoPtB” by adding a “B” element to “FePt” or “CoPt”. For example, see Japanese Laid-open Patent Publication No. 2004-311607, Japanese Patent Laid-open Patent Publication No. 2005-68486, and Oikawa, K., Yamaguchi, H., Kitakami, O., Okamoto, S., Shimada, Y., and Fukamichi, K., Effects of B and C on the ordering of L1o-CoPt thin films, American Institute of Physics, Applied Physics Letters, 2001, Vol. 79, Edition 13, [ISSN/ISBN]0003-6951.

However, these conventional techniques have a problem of requiring high-temperature thermal treatment for ordering an alloy. Specifically, thermal treatment at around 600° C. is necessary for ordering an alloy such as “CoPtB” and “FePtB”. The ground of being capable of suppressing the thermal treatment temperature required for ordering an alloy such as “CoPtB” and “FePtB” is attributable to a fact that the “B” element starts diffusion at a low temperature. An L1o structure can be obtained at a thermal treatment temperature of around 400° C. by coordinating Fe, Co, and Pt having stable energy into a cavity generated by shifting of the “B” element. However, the thermal treatment temperature required for ordering the alloy is still high.

### SUMMARY

According to an aspect of the present invention, a magnetic storage medium includes a substrate; a first magnetic layer film that is deposited on the substrate and contains a high magnetic anisotropic material and a low-temperature diffusion material which is added to the high magnetic anisotropic material, the low-temperature diffusion material starting diffusion by thermal treatment at a lower temperature than that of the high magnetic anisotropic material, and a second magnetic layer film that is a cap layer of the first magnetic layer film, and includes a material for promoting diffusion of the low-temperature diffusion material.

According to another aspect of the present invention, a manufacturing method of a magnetic storage medium includes depositing a first magnetic layer film on a substrate, the first magnetic layer film containing a high magnetic anisotropic material and a low-temperature diffusion material which is added to the high magnetic anisotropic material, the low-temperature diffusion material starting diffusion by thermal treatment at a lower temperature than that of the high magnetic anisotropic material; and depositing a second magnetic layer film that is a cap layer of the first magnetic layer film, the second magnetic layer film including a material for promoting diffusion of the low-temperature diffusion material.

According to still another aspect of the present invention, an information storage device includes a substrate; a first magnetic layer film that is deposited on the substrate and contains a high magnetic anisotropic material and a low-temperature diffusion material which is added to the high magnetic anisotropic material, the low-temperature diffusion material starting diffusion by thermal treatment at a lower temperature than that of the high magnetic anisotropic material, and a second magnetic layer film that is a cap layer of the first magnetic layer film, and includes a material for promoting diffusion of the low-temperature diffusion material.

The above and other features, advantages and technical and industrial significance of this invention will be better understood by reading the following detailed description of presently preferred embodiments of the invention, when considered in connection with the accompanying drawings.

### BRIEF DESCRIPTION OF DRAWINGS

FIG. 1 is a chart showing a dependence relationship between the thermal treatment temperature of ordering an alloy and a magnetic coercive force;

FIG. 2 is a chart showing a change of the magnetic coercive force relative to the thickness of a Ti film by thermal treatment at 300° C.;

FIG. 3 is a schematic diagram illustrating a manufacturing method of a magnetic storage medium;

FIG. 4A is a schematic diagram illustrating manufacturing of a resist shape pattern;

FIG. 4B is a schematic diagram illustrating milling;

FIG. 5A is a cross-sectional view of a milled magnetic laminated layer;

FIG. 5B is a cross-sectional view of a magnetic laminated layer having a milled recess embedded with Ti;

FIG. 5C is a cross-sectional view of a magnetic laminated layer planarized by a CMP process;

FIG. 5D is a cross-sectional view of a magnetic laminated layer having a DLC film formed thereon;

FIG. 6A is a cross-sectional view of a microfabricated magnetic laminated layer;

FIG. 6B is a cross-sectional view of a magnetic laminated layer having its recess after microfabrication embedded with Ti;

FIG. 6C is a cross-sectional view of a magnetic laminated layer planarized by a CMP process;

FIG. 6D is a cross-sectional view of a magnetic laminated layer having a DLC film formed thereon; and

FIG. 7 is a configuration example of an information storage device.

### DESCRIPTION OF EMBODIMENT

An exemplary embodiment of a magnetic storage medium, a manufacturing method of a magnetic storage medium, and an information storage device according to the present invention will be explained below in detail with reference to the accompanying drawings.

### Structure of Magnetic Storage Medium

A structure of a magnetic storage medium according to an embodiment of the present invention is explained first.

A magnetic storage medium disclosed by the present application includes a first magnetic layer film and a second magnetic layer film deposited on a substrate, the first magnetic layer film obtained by adding to a high magnetic anisotropic material a low-temperature diffusion material that starts diffusion by thermal treatment at a lower temperature than that of the high magnetic anisotropic material, and the second magnetic layer film that is a cap layer of the first magnetic layer film and includes a material promoting diffusion of the low-temperature diffusion material.

Specifically, the magnetic storage medium includes the first magnetic layer film obtained by adding a “B” element (boron) as the low-temperature diffusion material to “CoPt” or “FePt” as the high magnetic anisotropic material having high magnetic anisotropy, the “B” element starting diffusion by thermal treatment at a lower temperature than that of the high magnetic anisotropic material.

The “B” element of “CoPtB” or “FePtB” as the first magnetic layer film is an infiltration type in a state that the “B” element is infiltrated into a gap of a space lattice held by “CoPt” or “FePt”. Regarding diffraction of “CoFeB” used in a magnetic head, for example, when concentration of “B” becomes low, only diffraction intensity increases without changing a diffraction position.

The magnetic storage medium further includes the second magnetic layer film, which is a cap layer of the first magnetic layer film “CoPtB” or “FePtB” and includes “Ti” as a material promoting shifting of the low-temperature diffusion material “B” element by being strongly fixed to the low-temperature diffusion material “B”.

Regarding the strong fixing of the “B” element to “Ti”, it can be referred from Table 3 (table of boride and standard enthalpy change of formation) of Japanese Laid-open Patent Publication No. H9-195066 that, because the standard enthalpy change of formation of “TiB” is smaller than that of “NiB” as a magnetic material, “TiB” can be generated by stronger fixing than that of “CoB” or that of “FeB”.

That is, the magnetic storage medium has a structure including “CoPtB+Ti” or “FePtB+Ti” in a part of a magnetic multilayer including the first magnetic layer film “CoPtB” or “FePtB” and the second magnetic layer film “Ti” deposited on the substrate.

Thereafter, the magnetic storage medium including a laminated layer of “CoPtB+Ti” or “FePtB+Ti” is applied with thermal treatment to obtain an ordered alloy, that is, the “B” element is absorbed in the “Ti” layer, and “CoPt” or “FePt” as an fcc structure is transformed into an L1o structure.

That is, because the magnetic storage medium uses the material “Ti” strongly fixed to the “B” element as a cap layer to further promote diffusion of the “B” element as well as to start diffusion of the “B” element by low-temperature thermal treatment, the thermal treatment temperature of ordering an alloy can be reduced. Dependence relationship between thermal treatment temperature and magnetic coercive force

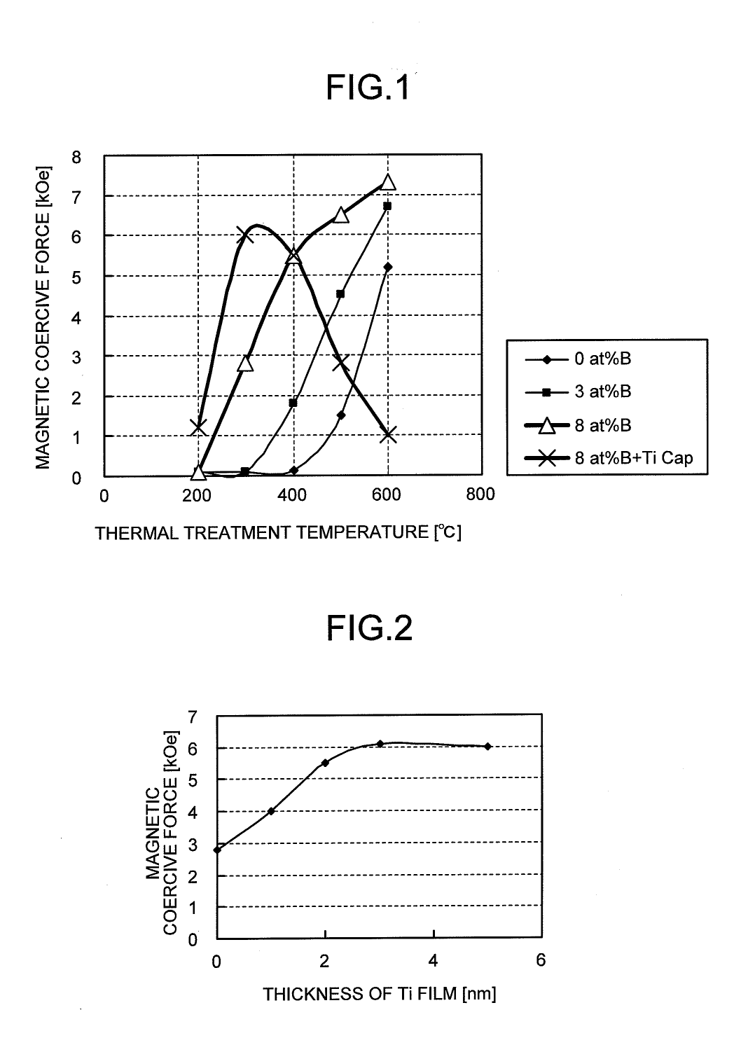

A dependence relationship between a thermal treatment temperature of ordering an alloy and a magnetic coercive force is explained with reference to FIG. 1. FIG. 1 is a chart showing the dependence relationship between a thermal treatment temperature of ordering an alloy and a magnetic coercive force.

FIG. 1 shows magnetic coercive forces of materials including (CoPt)₁₀₀₋ₓBₓ (x=0, 3, 8, respectively) deposited by 10 nanometers on a substrate and of a material including (CoPt)₉₂B₈ deposited by 10 nanometers and “Ti” deposited by 5 nanometers on a substrate, when each material is thermally treated at 200° C., 300° C., 400° C., 500° C., and 600° C.

As shown in FIG. 1, by adding the “B” element, a high magnetic coercive force is held even when a thermal treatment temperature of ordering an alloy is kept low. When “Ti”, which is strongly fixed to the “B” element, is used as a cap layer, a higher magnetic coercive force is held at a lower thermal treatment temperature.

For example, as shown in FIG. 1, when thermal treatment is performed at 400° C., the magnetic coercive force is “0 at. % B: 0.2 kOe”, “3 at. % B: 1.9 kOe”, and “8 at. % B: 5.4 kOe”. Therefore, when the “B” element is added, a high magnetic coercive force can be maintained even when a thermal treatment temperature is set low.

For example, as shown in FIG. 1, when thermal treatment is performed at 300° C., the magnetic coercive force is “8 at. % B+Ti (cap): 6.2 kOe”. Therefore, when “Ti” is used as a cap layer, a high magnetic coercive force can be maintained at a lower thermal treatment temperature. When thermal treatment is performed at a higher temperature than 400° C., the magnetic coercive force of “8 at. % B+Ti” decreases because “Ti” starts diffusing.

### Thickness of Ti Film

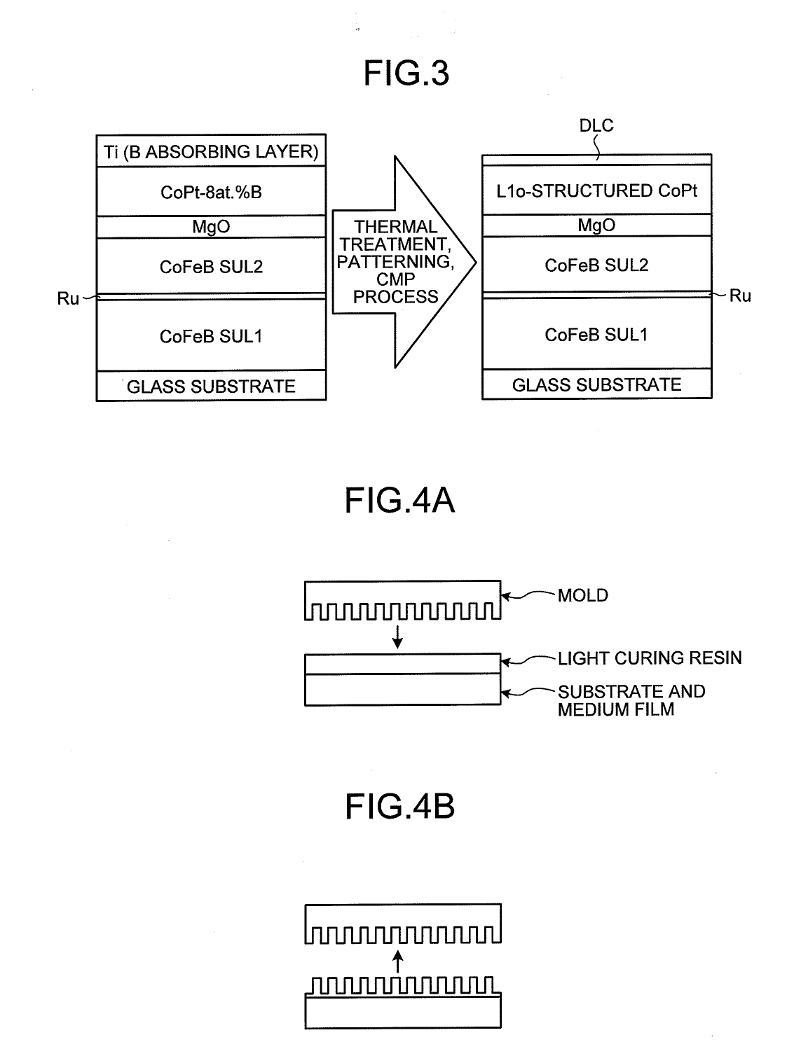

A change of a magnetic coercive force relative to a thickness of a Ti film is explained next with reference to FIG. 2. FIG. 2 is a chart showing a change of a magnetic coercive force relative to a thickness of a Ti film by thermal treatment at 300° C.

FIG. 2 shows a relationship between the thickness of a Ti film and the magnetic coercive force of a material including (CoPt)₉₂B₈ deposited by 10 nanometers and “Ti” deposited by “y” nanometers (y=1, 2, 3, 5) on a substrate, when the material is thermally treated at 300° C. As shown in FIG. 2, the magnetic coercive force is saturated when a film thickness of “Ti” is larger than 2 nanometers. Accordingly, the film thickness of the “Ti” film used as a cap layer is set larger than 2 nanometers.

For example, as shown in FIG. 2, the magnetic coercive force becomes 4 kOe when Ti is deposited by 1 nanometer, and becomes 5.4 kOe when Ti is deposited by 2 nanometers. Further, the magnetic coercive force becomes 6.1 kOe when Ti is deposited by 3 nanometers, and becomes 6 kOe when Ti is deposited by 5 nanometers. Accordingly, when the material is thermally treated at 300° C., the magnetic coercive force is saturated when a film thickness of Ti is larger than 2 nanometers.

That is, when “Ti”, which is strongly fixed to the “B” element that starts diffusion by low-temperature thermal treatment, is used as a cap layer, the magnetic coercive force is saturated when “Ti” is deposited by more than 2 nanometers. Therefore, it suffices that the magnetic storage medium includes the “Ti” deposited by more than 2 nanometers.

### Manufacturing Method of Magnetic Storage Medium

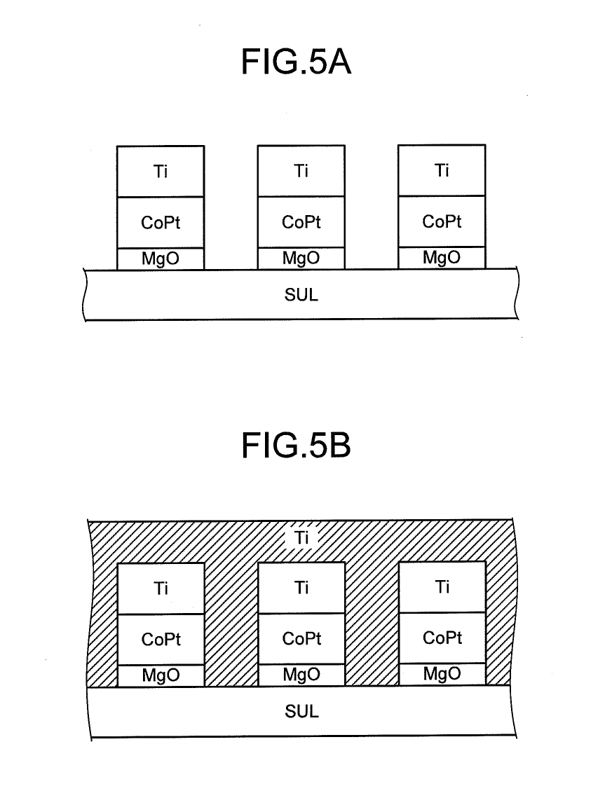

A manufacturing method of the magnetic storage medium is explained next with reference to FIG. 3. FIG. 3 is a schematic diagram illustrating the manufacturing method of a magnetic storage medium.

The magnetic storage medium further includes a crystalline orientation layer made of MgO in a lower layer of the first magnetic layer film. The MgO is deposited onto CoFeB as a soft magnetic layer on a substrate.

For example, as shown in FIG. 3, CoFeB is deposited by 25 nanometers and Ru is deposited by 1.8 nanometers as an SUL1 layer of an anti-parallel structure soft under layer (APS-SUL), and CoFeB is deposited by 25 nanometers as an SUL2 layer, on a glass substrate.

Further, MgO is deposited by 3 to 5 nanometers as a crystalline-orientation control layer of a recording layer, on an amorphous CoFeB. When MgO is deposited onto the amorphous CoFeB in this way, the MgO is crystalline orientated on a (001) surface, thereby completing a template layer to orientate CoPt or FePt on the (001) surface. CoPtB or FePtB is deposited by 10 nanometers, and Ti is deposited by 5 nanometers on the CoPtB layer or the FePtB layer, thereby completing a magnetic laminated layer of a recording medium (see the left view in FIG. 3).

The completed laminated layer is thermally treated at about 300° C. to obtain CoPt or FePt of an L1o structure. Accordingly, when forming a film, a crystalline Ti layer absorbs the B element, and is transformed into an amorphous layer, and the CoPt layer is transformed from an fcc structure into the L1o structure.

However, the magnetic laminated layer completed as described above includes continuous magnetic substance and a Ti layer. Therefore, a distance between a write head and SUL (distance between an air bearing surface (ABS) and SUL) is long. Further, the completed magnetic laminated layer cannot obtain a desired writing magnetic field. Therefore, this magnetic laminated layer cannot be directly used as a magnetic storage medium.

Therefore, to use the completed magnetic laminated layer as a magnetic storage medium, the magnetic layer needs to be a bit-patterned medium (BPM), in which the layer is divided into each one bit from a continuous film. After the magnetic laminated layer is processed, this layer is polished by chemical mechanical polishing (CMP) to planarize the layer in order to decrease the ABS-SUL distance. Further, the Ti layer used as a cap layer is removed (see the right view in FIG. 3).

The process into ion beam etching (IBE) and reactive ion etching (RIE) which are included in a manufacturing (fabrication) process of a magnetic storage medium are separately explained below.

Fabrication by IBE

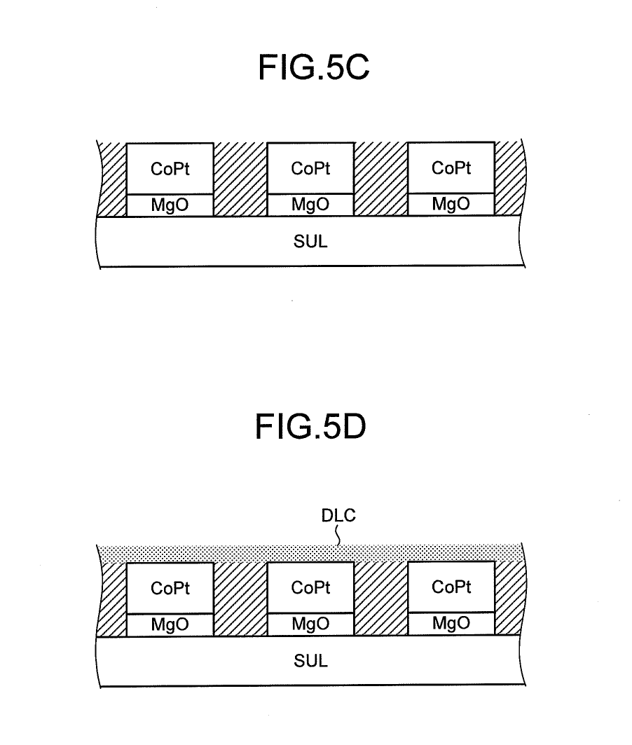

As shown in FIG. 4A, a resist (a light curing resin) that becomes a protection film is coated onto a magnetic laminated layer (a substrate or a medium film). A mold formed in a medium bit pattern is pressed against the magnetic laminated layer, thereby manufacturing a resist shape pattern. FIG. 4A is a schematic diagram illustrating manufacturing of a resist shape pattern.

As shown in FIG. 4B, the manufactured shape pattern is milled by IBE, thereby etching the CoPt layer. The milling by IBE is stopped at the MgO layer to prevent the occurrence of loss (erasing) of a recording state of an adjacent track due to a leaked magnetic field because of collapse of a magnetic distribution of an SUL uniformly internally magnetized, attributable to generation of unevenness on the SUL layer.

The MgO layer has a thickness of 3 to 5 nanometers to avoid decrease of a medium magnetic field due to an increased distance between the ABS and the SUL when the MgO is too thick. The MgO layer has a thickness of 3 to 5 nanometers also because fabrication margin cannot be obtained when the MgO film is too thin. FIG. 4B is a schematic diagram for explaining the milling.

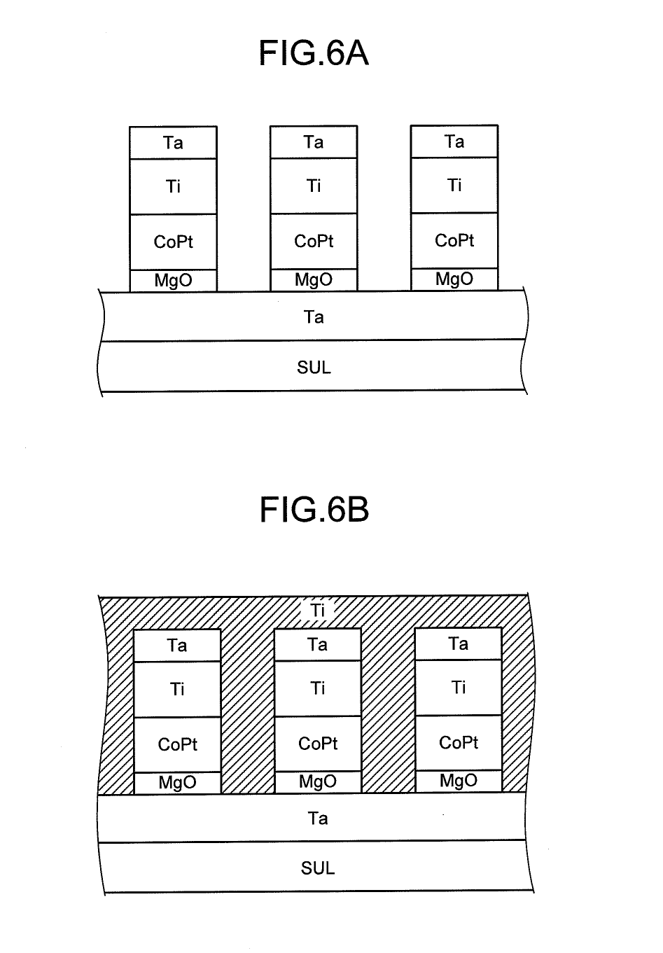

Subsequently, the milled magnetic laminated layer (see FIG. 5A) has its recess portion embedded with Ti as a nonmagnetic material (see FIG. 5B). Ti is used for the material to embed the recess, to minimize a stage generated by a difference of a polishing rate of CMP described later, by embedding the recess with the same material as Ti used at a top portion of the CoPt layer. FIG. 5A is a cross-sectional view of the milled magnetic laminated layer, and FIG. 5B is a cross-sectional view of the magnetic laminated layer having the milled recess embedded with Ti.

Thereafter, the medium having the recess embedded with Ti has the resist and the Ti layer absorbing the B element, planarized by a CMP process (see FIG. 5C). The CMP-processed medium has a diamond like carbon (DLC) film formed thereon as a protection layer (see FIG. 5D). FIG. 5C is a cross-sectional view of the magnetic laminated layer planarized by the CMP process, and FIG. 5D is a cross-sectional view of the magnetic laminated layer having a DLC film formed thereon.

A bit-patterned medium having CoPt of the L1o structure is completed by the IBE process described above.

### Processing by RIE

To perform microfabrication by the RIE process, Ta is deposited by 3 nanometers, MgO is deposited by 2 nanometers, CoPtB is deposited by 10 nanometers, Ti is deposited by 5 nanometers, and Ta is deposited by 5 nanometers on the APS-SUL layer, as a laminated layer, for example. In a similar manner to that of the IBE process, a resist (a light curing resin) that becomes a protection film is coated onto the magnetic laminated layer, and a mold formed in a medium bit pattern is pressed against the magnetic laminated layer, thereby manufacturing a resist shape pattern (see FIG. 4A).

A Ta mask (Ta at an upper part) of the manufactured shape pattern is then milled by IBE. Thereafter, the CoPt film is microfabricated by an RIE process using Co—NH₃. Etching is stopped at a Ta layer (Ta at a lower part) of an MgO lower layer (see FIG. 4B).

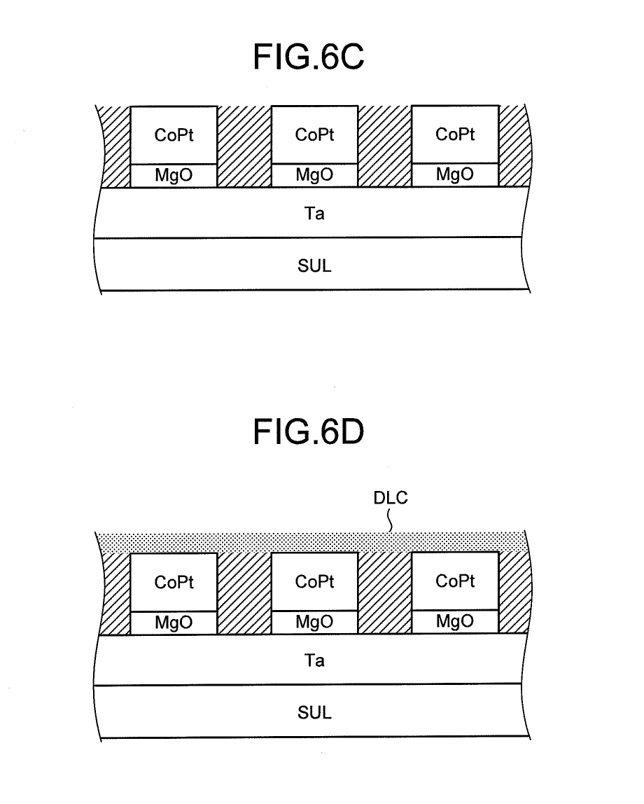

The microfabricated magnetic laminated layer (see FIG. 6A) has its recess portion embedded with Ti as a nonmagnetic material (see FIG. 6B). FIG. 6A is a cross-sectional view of the microfabricated magnetic laminated layer, and FIG. 6B is a cross-sectional view of the magnetic laminated layer having its recess after the microfabrication embedded with Ti.

Thereafter, the medium having the recess embedded with Ti has the resist, as well as the Ti layer and the Ta layer absorbing the B element, planarized by the CMP process (see FIG. 6C). Subsequently, the CMP-processed medium has a DLC film formed thereon as a protection layer (see FIG. 6D). FIG. 6C is a cross-sectional view of the magnetic laminated layer planarized by the CMP process, and FIG. 6D is a cross-sectional view of the magnetic laminated layer having a DLC film formed thereon.

A bit-patterned medium having CoPt of the L1o structure is completed by the RIE process described above.

### Information Storage Device

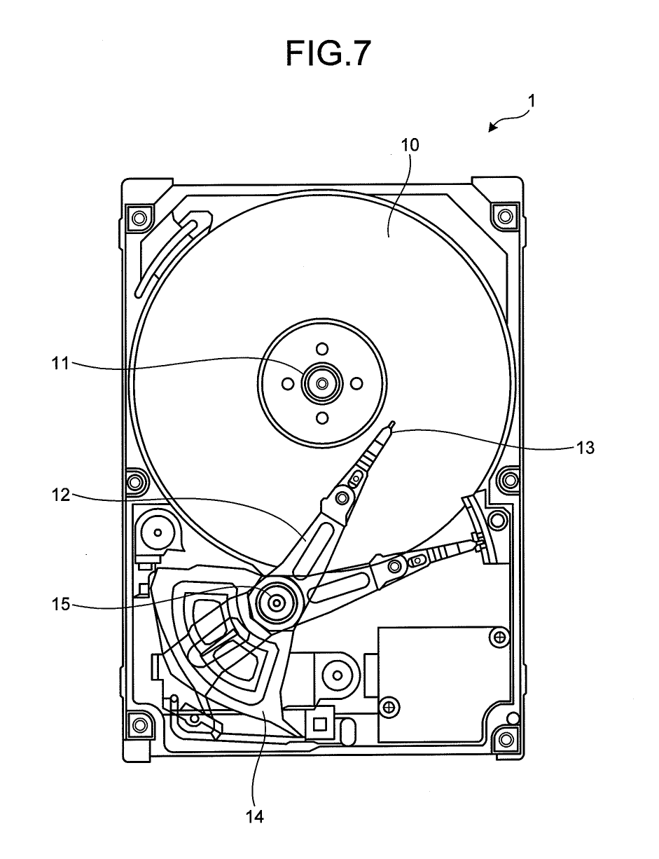

A configuration of an information storage device including the magnetic storage medium described above is explained next with reference to FIG. 7. FIG. 7 is a configuration example of the information storage device.

Specifically, the information storage device includes a magnetic storage medium including a first magnetic layer film and a second magnetic layer film deposited on a substrate, the first magnetic layer film obtained by adding to a high magnetic anisotropic material a low-temperature diffusion material that starts diffusion by thermal treatment at a lower temperature than that of the high magnetic anisotropic material, and the second magnetic layer film that is a cap layer of the first magnetic layer film and includes a material promoting diffusion of the low-temperature diffusion material.

For example, as shown in FIG. 7, a magnetic storage medium 10 of an information storage device 1 is a vertical magnetic storage medium that stores various kinds of information in high density, and is rotated by a spindle motor 11.

Writing and reading of information in and from the magnetic storage medium 10 is performed by a head 13 provided at one front end of an arm 12 as a head supporting mechanism. The head 13 performs writing while maintaining a state that the head 13 is slightly floated above the surface of the magnetic storage medium 10 by a lifting force generated by rotation of the magnetic storage medium 10.

Further, the arm 12 rotates on a circle centering around an axis 15 based on driving of a voice coil motor 14 as a head driving mechanism provided at the other end of the arm 12. The head 13 moves (seeks) to a track lateral direction of the magnetic storage medium 10, and changes a target track to write and read information.

As described above, the magnetic storage medium includes a low-temperature diffusion material added to a high magnetic anisotropic material requiring thermal treatment at a high temperature and having high magnetic anisotropy, the low-temperature diffusion material starting diffusion by thermal treatment at a lower temperature than that of the high magnetic anisotropic material. The magnetic storage medium further includes a material promoting shifting of the low-temperature diffusion material by being strongly fixed to the added low-temperature diffusion material. Therefore, a thermal treatment temperature of ordering an alloy can be reduced.

For example, the magnetic storage medium has the first magnetic layer film obtained by adding a B element as the low-temperature diffusion material to CoPt or FePt as the high magnetic anisotropic material having high magnetic anisotropy, the B element starting diffusion by thermal treatment at a lower temperature than that of the high magnetic anisotropic material. The magnetic storage medium further includes the second magnetic layer film, which is the cap layer of the first magnetic layer film CoPtB or FePtB and includes Ti as a material promoting shifting of the low-temperature diffusion material B element by being strongly fixed to the low-temperature diffusion material B. As a result, a thermal treatment temperature of ordering an alloy can be reduced.

While embedding a recess of a milled magnetic laminated layer with Ti has been explained in the above embodiment, the present invention is not limited thereto, and any material can be used as far as it is a nonmagnetic material.

According to an embodiment of the magnetic storage medium, the manufacturing method of a magnetic storage medium, and the information storage device disclosed by the present application, the thermal treatment temperature of ordering an alloy can be reduced.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A magnetic storage medium comprising:
a substrate;
a first magnetic layer film that is deposited on the substrate and contains a high magnetic anisotropic material and a low-temperature diffusion material which is added to the high magnetic anisotropic material, the low-temperature diffusion material starting diffusion by thermal treatment at a lower temperature than that of the high magnetic anisotropic material, and
a second magnetic layer film that is a cap layer of the first magnetic layer film, and includes a material for promoting diffusion of the low-temperature diffusion material.

2. The magnetic storage medium according to claim 1, wherein
the first magnetic layer film contains a material selected from the group consisting of CoPtB and FePtB, the CoPtB containing CoPt as the high magnetic anisotropic material and B as the low-temperature diffusion material, the FePtB containing FePt as the high magnetic anisotropic material and B as the low-temperature diffusion material, and
the second magnetic layer film is made of Ti.

3. The magnetic storage medium according to claim 1, wherein the second magnetic layer film has a thickness of larger than 2 nanometers.

4. The magnetic storage medium according to claim 1, further comprising a crystalline orientation layer that is made of MgO and is provided between the substrate and the first magnetic layer film.

5. The magnetic storage medium according to claim 4, further comprising a CoFeB layer that is a crystalline orientation layer and is deposited on the substrate, the crystalline orientation layer is deposited on the CoFeB layer.

6. A manufacturing method of a magnetic storage medium, comprising:
depositing a first magnetic layer film on a substrate, the first magnetic layer film containing a high magnetic anisotropic material and a low-temperature diffusion material which is added to the high magnetic anisotropic material, the low-temperature diffusion material starting diffusion by thermal treatment at a lower temperature than that of the high magnetic anisotropic material; and
depositing a second magnetic layer film that is a cap layer of the first magnetic layer film, the second magnetic layer film including a material for promoting diffusion of the low-temperature diffusion material.

7. An information storage device comprising:
a substrate;
a first magnetic layer film that is deposited on the substrate and contains a high magnetic anisotropic material and a low-temperature diffusion material which is added to the high magnetic anisotropic material, the low-temperature diffusion material starting diffusion by thermal treatment at a lower temperature than that of the high magnetic anisotropic material, and
a second magnetic layer film that is a cap layer of the first magnetic layer film, and includes a material for promoting diffusion of the low-temperature diffusion material.
